(19) United States
(12) Patent Application Publication
(10) Pub. No.: US 2020/0389738 A1
(43) Pub. Date: Dec. 10, 2020

(54) HIGH-QUALITY ELECTROMAGNETIC SPEAKER HAVING IMPROVED ACCURACY OF AIR GAP

(71) Applicant: EARBRIDGE INC., Incheon (KR)

(72) Inventor: Ok Jeong YOO, Pocheon-si (KR)

(73) Assignee: EARBRIDGE INC., Incheon (KR)

(21) Appl. No.: 16/478,316

(22) PCT Filed: Dec. 18, 2017
(86) PCT No.: PCT/KR2017/014918

§ 371 Date: Dec. 13, 2019

(30) Foreign Application Priority Data
Jan. 16, 2017 (KR) 10-2017-0006958

(51) Int. Cl. H04R 9/06; H04R 7/04; H04R 7/18; H04R 9/02; H04R 9/04; H04R 7/24

(52) U.S. Cl. CPC H04R 9/06; H04R 7/04; H04R 7/24; H04R 9/025; H04R 9/046; H04R 7/18

(57) ABSTRACT

An embodiment relates to a high-quality electromagnetic speaker having improved accuracy of an air gap, wherein coils stacked on an upper part and a lower part of a vibration module are reliably and accurately set by respective fixing members, whereby the coils are disposed so that air gaps are formed mutually symmetrically at an equal distance in an upper part and a lower part with respect to a vibration plate. Accordingly, the present invention can be very usefully used in the electromagnetic speaker field that aims to exclude the distortion caused by asymmetry of air gaps and the non-uniformity of other acoustic conversion characteristics.

### TECHNICAL FIELD

The present invention relates to a high-quality electromagnetic speaker having improved accuracy of an air gap and, more particularly, to a high-quality electromagnetic speaker having improved accuracy of an air gap, in which coils stacked on an upper part and a lower part of a vibration module are reliably and accurately set by respective fixing members, whereby the coils are disposed so that air gaps are formed mutually symmetrically at an equal distance in an upper part and a lower part with respect to a vibration plate, thereby excluding the distortion caused by asymmetry of air gaps and the non-uniformity of other acoustic conversion characteristics.

### BACKGROUND ART

Generally, an electromagnetic speaker is similar in operation principle to a coin-type speaker in which the force is generated by the interaction of the AC magnetic field lines generated from coils around which lead wires are wound and the DC magnetic field lines derived from permanent magnets. However, the electromagnetic speaker performs electro-acoustic conversion by causing the coil to be fixed and an iron piece attached to one end of the coil to be electro-magnetized and thus vibrated, unlike the coin-type in which the coil is directly driven.

The electromagnetic speaker includes a balanced armature speaker and a plate-type speaker. Among these electromagnetic speakers, the plate-type speaker is disclosed in Korean Patent Registration No. 1596894 (Patent Document 1).

In the electromagnetic speaker of Patent Document 1, the upper and lower coils are disposed in correspondence with each other, permanent magnets are arranged on the outer sides of the upper and lower coils, a vibration plate is disposed between the upper and lower coils, in which the vibration plate is disposed between permanent magnets together with a gap-guide so that upper surface and lower surface edges of the vibration plate are supported by upper and lower damper members.

In the electromagnetic-type speaker configured as described above in the related art, the vibration plate is electro-magnetized by the electromagnetic force of the upper and lower coils and is directly driven by the reaction with the magnetic force of the permanent magnet in a state where the weight of the coil is excluded, whereby it is possible to realize a quick response to an electric signal and thus very detailed sound reproduction.

In addition, since the vibration plate is actively driven by itself to perform sound conversion, the distortion rate of a displacement path of the vibration module can be minimized, resulting in that it is advantageous for the reproduction of clean sound.

However, in the electromagnetic speaker as described above in the related art, since the magnetic circuit is simply configured to have a coil inserted into the inner side of the permanent magnet, the position of the coil cannot be accurately set, whereby it is difficult to allow air gaps between coils provided at a upper part and a lower part with respect to the vibration plate to be maintained mutually symmetrically at an equal distance.

Therefore, there is a problem in that the distortion caused by asymmetry of the air gaps and the non-uniformity of other acoustic conversion characteristics cannot be eliminated.

Further, since a pair of magnetic circuits is provided in which the coils are fitted in the inner side of the permanent magnets and then the gap guide is assembled in a manner to be disposed between the permanent magnets of the magnetic circuit, the assembly tolerance is inevitably generated in the magnetic circuits. Accordingly, it is difficult to maintain the symmetry between the upper coil and the lower coil and to achieve the uniformity of the sound pressure/characteristics in operation.

Further, the lower damper ring, the vibration plate, and the upper damper ring are sequentially assembled on an inner surface of the ring-shaped gap guide. However, since the vibration plate is configured to be supported by the separate upper and lower damper rings, there are many members and assembling processes, and it is impossible to be modularized or unified, whereby an unevenness of the gap height and the damper-ring dimension may be generated. Accordingly, there are problems that it is disadvantageous to implement the uniformity of characteristics/sound pressure/reproduction frequency, and also a possibility of bass leakage exists.

### DISCLOSURE

### Technical Problem

The present invention has been researched and developed to overcome the problems and disadvantages of the conventional electromagnetic speaker as described above, and has an objective to provide a high-quality electromagnetic speaker having improved accuracy of an air gap, in which coils stacked on an upper part and a lower part of a vibration module are reliably and accurately set by respective fixing members, whereby the coils are disposed so that air gaps are formed mutually symmetrically at an equal distance in an upper part and a lower part with respect to a vibration plate, thereby excluding the distortion caused by asymmetry of air gaps and the non-uniformity of other acoustic conversion characteristics.

In addition, according to an embodiment of the present invention, it is an objective to provide a high-quality electromagnetic speaker having improved accuracy of an air gap, in which the vibration plate and the upper and lower dampers are integrated in one piece through the upper and lower housings and so as to provide the vibration module, whereby it is possible to automatize the assembling operation using a separate preparation process and minimizing the manual operation which can influence manufacturing cost.

In addition, according to an embodiment of the present invention, it is an objective to provide a high-quality electromagnetic speaker having improved accuracy of an air gap, in which the vibration plate of the vibration module and the upper and lower housings are provided as magnetic bodies and the upper and lower dampers are provided as nonmagnetic bodies enabling the control of the elasticity modulus, so as to minimize the magnetic resistance and leakage magnetic flux between the permanent magnets and to increase the bias magnetic force, whereby the vibration plate is excluded from reverse phase and is driven to be same phase in the entire area, thereby reducing the phase difference distortion and improving the acoustic conversion efficiency.

The problems to be solved in the embodiments are not limited to these, and the objects and effects that can be grasped from the solution means and the embodiments of the problems described below are also included.

### Technical Solution

A high-quality electromagnetic speaker having improved accuracy of an air gap according to an embodiment of the present invention includes: a vibrating module including a vibrating plate; a first magnetic circuit disposed in a upper part of the vibration module; and a second magnetic circuit disposed in a lower part of the vibration module, wherein the first magnetic circuit includes a first permanent magnet disposed in the upper part of the vibration module, a first coil disposed inward of the first permanent magnet, and a first fixing member formed to protrude toward the second magnetic circuit to fix the first coil; and the second magnetic circuit includes a second permanent magnet disposed in the lower part of the vibration module, a second coil disposed inward of the second permanent magnet, and a second fixing member formed to protrude toward the first magnetic circuit to fix the second coil.

The first coil may be disposed to be flattened with a top surface of the first permanent magnet and protrudes from a bottom surface of the first permanent magnet, the second coil may be disposed to be flattened with a bottom surface of the second permanent magnet and protrudes from a top surface of the second permanent magnet, and the first coil and the second coil may be disposed so that air gaps are formed mutually symmetrically at an equal distance with respect to the vibration plate.

The vibration module may include ring-shaped upper and lower dampers for supporting the top and bottom surfaces of the vibration plate, and upper and lower housings for fixing the upper and lower dampers together with the vibration plate, and the upper and lower housings have an angle type cross section.

The vibration plate may have a mass body disposed at the center thereof.

The vibration plate may include a plurality of extension holes extending radially in a center hole and a plurality of vibration blades disposed between the plurality of extension holes.

The speaker may further include a cushion pad disposed between the first magnetic circuit and an inner surface of the housing to prevent acoustic leakage and prevent damage to the coil.

The speaker may further include a shield magnet disposed so that a polarity of an upper surface of the first permanent magnet is the same to that of a lower surface of the second permanent magnet; a shield guide surrounding outer surfaces of the vibration module, the first and second permanent magnets, and the shield magnet; and a shield plate disposed on bottom surfaces of the second permanent magnet and the shield guide, wherein the shield guide is a non-magnetic body, and the shield plate is a magnetic body.

The speaker may further include a first magnetic damper disposed between the first fixing member and the vibration plate and a second magnetic damper disposed between the second fixing member and the vibration plate.

The first and second magnetic dampers may include a polymer resin and particles dispersed in the polymer resin, and the particles include ferromagnetic powder or particles.

### Advantageous Effects

According to the present invention, it is possible to provide a high-quality electromagnetic speaker having improved accuracy of an air gap, in which coils stacked on an upper part and a lower part of a vibration module are reliably and accurately set by respective fixing members, whereby the coils are disposed so that air gaps are formed mutually symmetrically at an equal distance in an upper part and a lower part with respect to a vibration plate, thereby excluding the distortion caused by asymmetry of air gaps and the non-uniformity of other acoustic conversion characteristics.

Further, the present invention has an advantage that it is possible to control the acoustic conversion efficiency by controlling the air gap with the vibration plate through control of the depth of the boater of the fixing member.

Further, the present invention has an advantage that since the vibration plate and the upper and lower dampers and are integrated in one piece through the upper and lower housings and so as to provide the vibration module, it is possible to automatize the assembling operation using a separate preparation process and minimizing the manual operation which can influence manufacturing cost.

Further, the present invention has an advantage that since the vibration plate of the vibration module and the upper and lower housings are provided as magnetic bodies and the upper and lower dampers are provided as nonmagnetic bodies enabling the control of the elasticity modulus, it is possible to minimize the magnetic resistance and leakage magnetic flux between the permanent magnets and to increase the bias magnetic force, whereby the vibration plate is excluded from reverse phase and is driven to be same phase in the entire area, thereby reducing the phase difference distortion and improving the acoustic conversion efficiency.

While the present invention has been particularly shown and described with reference to exemplary embodiments thereof, it is to be understood that the invention is not limited to the disclosed exemplary embodiments.

### DESCRIPTION OF DRAWINGS

FIG. 1 is an exploded view of a high-quality electromagnetic speaker having improved accuracy of an air gap according to a preferred embodiment of the present invention.

FIG. 2 is an assembled cross-sectional view of a high-quality electromagnetic speaker having improved accuracy of an air gap according to the present invention.

FIG. 3 is a plan view of FIG. 2.

FIG. 4 is a bottom view of FIG. 2.

FIG. 5 is a detailed plan view showing a vibration module in an electromagnetic speaker according to the present invention.

FIG. 6 is a cross sectional view of FIG. 5.

FIGS. 7 and 8 are cross-sectional views showing another embodiment of a vibration plate of a vibration module in an electromagnetic speaker according to the present invention.

FIG. 9 is a cross-sectional view illustrating a high-quality electromagnetic speaker having improved accuracy of an air gap according to another embodiment of the present invention.

FIG. 10 is a plan view showing a vibration plate applied to the vibration module of FIG. 9.

FIGS. 11 to 13 are cross-sectional views illustrating a high-quality electromagnetic speaker having improved accuracy of an air gap according to still another embodiment of the present invention.

### MODE FOR INVENTION

While the invention is susceptible to various modifications and alternative forms, specific embodiments thereof are shown by way of example in the drawings and will herein be described in detail. It is to be understood, however, that the invention is not to be limited to the specific embodiments, but includes all modifications, equivalents, and alternatives falling within the spirit and scope of the invention.

The terms used in the present application are used only to illustrate specific embodiments and are not intended to limit the invention. The singular expressions include plural expressions unless the context clearly dictates otherwise. In the present application, the terms “comprises”, “having”, or the like are used to specify that there is a feature, a number, a step, an operation, an element, a component or a combination thereof described in the specification, but do not preclude the presence or addition of one or more other features, integers, steps, operations, elements, components, or combinations thereof.

Unless defined otherwise, all terms used herein, including technical or scientific terms, have the same meaning as commonly understood by one of ordinary skill in the art to which this invention belongs. Terms such as those defined in commonly used dictionaries are to be interpreted as having a meaning consistent with the contextual meaning of the related art and are to be interpreted as either ideal or overly formal in the sense of the present application.

Hereinafter, embodiments will be described in detail with reference to the accompanying drawings, wherein like or corresponding elements are denoted by the same reference numerals, and redundant description thereof will be omitted.

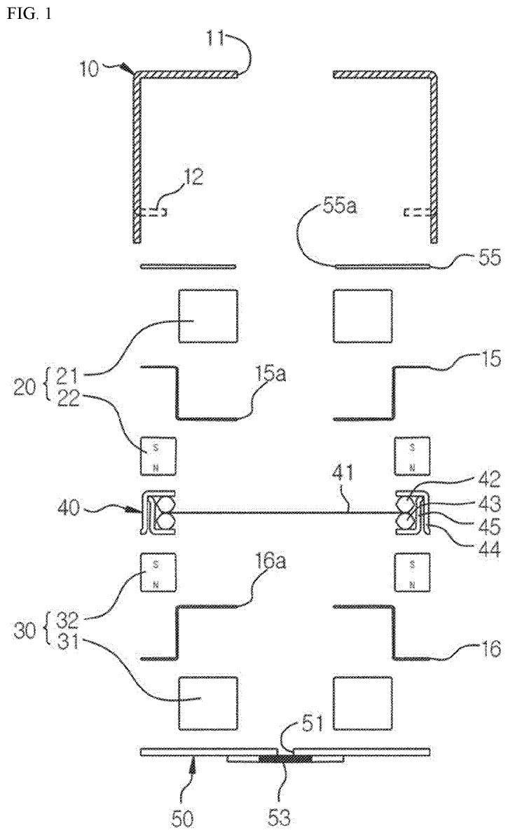

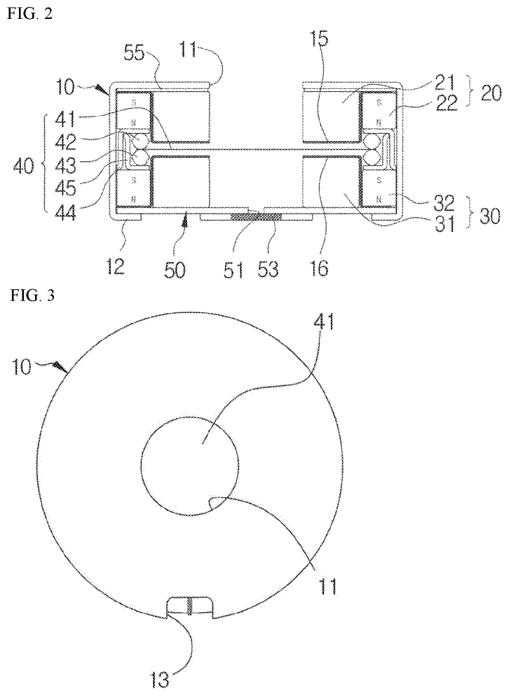

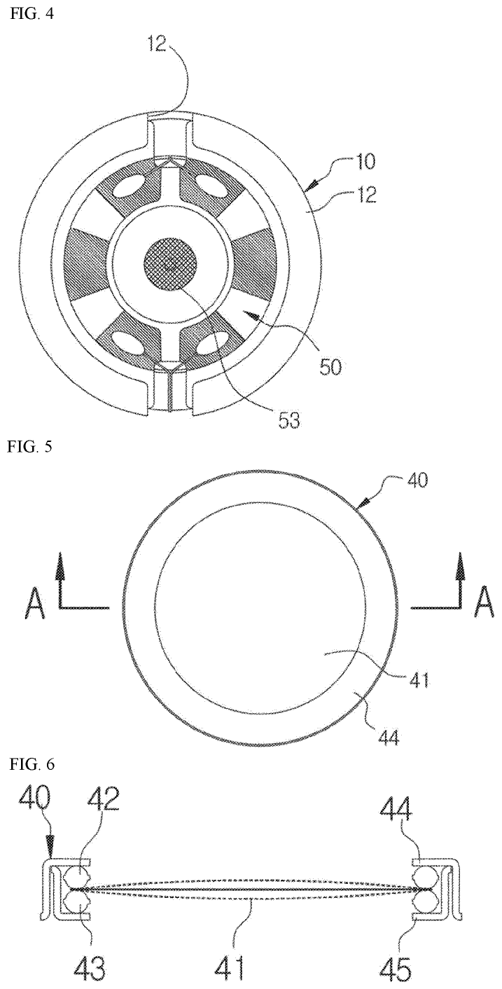

FIGS. 1 to 6 are views illustrating a high-quality electromagnetic speaker having improved accuracy of an air gap according to an embodiment of the present invention.

As shown in the drawings, a high-quality electromagnetic speaker having improved accuracy of an air gap according to the present invention includes a housing 10 having a hollow cap-shaped cross section, a first washer-type magnetic circuit 20 mounted in an upper space in the housing 10, a second washer-type magnetic circuit 30 disposed below the first magnetic circuit 20 in opposite thereto, and a vibration module 40 disposed between the magnetic circuits.

The housing 10 should have a space in which the vibration module 40 and the electrode member 50 as well as the first and second magnetic circuits 20 and 30 are installed, and thus have the hollow cap-shaped cross section in an entire shape. The housing 10 is formed with a non-magnetic material, or a semi-magnetic material such as aluminum, magnesium, or a polymer, but the shape and material of the housing 10 are not necessarily limited thereto.

The housing 10 has a first acoustic radiation outlet 11 formed at the center of a top surface thereof and a coil withdrawing groove 13 cut from one side of the top surface to the end of a lower part thereof. A plurality of bending members 12 is formed in a manner to make it possible to be bent in the direction of the center of the housing 10 may be formed at the lower end of the cap-shaped cross section, so as to mount components assembled in the installation space.

The first and second magnetic circuits 20 and 30 are provided so that coils and permanent magnets are paired and horizontally arranged. That is, the first magnetic circuit 20 includes a first coil 21 and a first permanent magnet 22, and the second magnetic circuit 30 includes a second coil 31 and a second permanent magnet 32.

The first and second coils 21 and 31 may be safely positioned inward of the first and second permanent magnets 22 and 32 through first and second fixing members 15 and 16.

The first fixing member 15 is disposed on the top surface of the first permanent magnet 22 and is provided in a boater type in which the center portion thereof protrudes downward to cause the first coil 21 to be safely positioned and a second acoustic radiation outlet 15a is formed in the center portion thereof.

The second fixing member 16 is disposed on the bottom of the second permanent magnet 32 and is provided in a boater type in which the center portion thereof protrudes upward to cause the second coil 31 to be safely positioned and a third acoustic radiation outlet 16a is formed in the center portion thereof.

The first and second fixing members 15 and 16 may include a non-magnetic material, a semi-magnetic material such as aluminum, magnesium, or a polymer, as in the case of the housing 10. However, the material of the first and second fixing members 15 and 16 is not particularly limited.

The first permanent magnet 22 of the first magnetic circuit 20 is stacked on the upper part of the vibration module 40, and the first washer-type coil 21 is safely positioned by the first fixing member 15 inward of the first permanent magnet 22.

The second permanent magnet 32 of the second magnetic circuit 30 is stacked on the bottom portion of the vibration module 40, and the second washer-type coil 31 is safely positioned by the second fixing member 16 inward of the second permanent magnet 32. Accordingly, the first and second magnetic circuits 20 and 30 may be disposed symmetrically with respect to the vibration module 40.

The first and second coils 21 and 31 are provided to be flattened with the top surface of the first permanent magnet 22 and the bottom surface of the second permanent magnet 32, respectively and protrude below the bottom surface of the first permanent magnet 22 and above the top surface of the second permanent magnet 32, respectively, thereby forming air gaps that are at an equal distance and mutually symmetrical with respect to the vibration plate 41.

The first and second coils 21 and 31 and the first and second permanent magnets 22 and 32 of the first and second magnetic circuits 20 and 30 are concentrically horizontally arranged on the top and bottom surfaces of the vibration module 40, respectively, so that a thin slim electromagnetic speaker may be obtained.

In addition, since the first and second fixing members 15 and 16 may be provided to make the depth (protruding depth) of the boater lower or deeper, the distances between the vibration plate 41 and the respective first and second coil 21 and 31 inward of the first and second permanent magnets 22 and 32 are symmetrical to each other and precise control of the air gaps is possible, so that the acoustic conversion efficiency can be controlled.

Particularly, the first and second coils 21 and 31 are securely and precisely set in height and position inward of the first and second permanent magnets 22 and 32 through the first and second fixing members 15 and 16. As a result, it is possible to provide the air gaps that are formed at an equal distance and mutually symmetrically with respect to the vibration plate 41, thereby excluding the distortion caused by asymmetry of air gaps and the non-uniformity of other acoustic conversion characteristics, and further obtaining electromagnetic speaker of a uniform high quality having a very small variation in sound pressure, characteristics, and sound quality.

The electrode member 50 is provided in the form of a plate having a fourth acoustic radiation outlet 51 formed at the center thereof to be disposed on the bottom surface of the second permanent magnet 32 of the second magnetic circuit 30, and connected to the first and second coils 21 and 31 to serve to supply electric current.

The fourth acoustic radiation outlet 51 of the electrode member 50 may be provided with a resistor 53 for controlling the fine sound from the middle to the high sound generated by the vibration plate 41. The resistor 53 may be a porous material. For example, the resistor 53 may be used with felt, microporous material, or the like, but the present invention is not limited thereto.

In addition, the first coil 21 and the second coil 31 are connected to each other such that magnetic force lines of the respective coils flow so as to face each other, whereby the vibration plate 41 of the vibration module 40 electro-magnetized may obtain the power from the first and second coils 21 and 31.

The vibration plate 41 may vibrate up and down in response to positive and negative electrical period signals applied to the first and second coils 21 and 31.

The vibration module 40 is installed between the first and second permanent magnets 22 and 32 arranged symmetrically up and down. The vibration module 40 includes a vibration plate 41, ring-shaped upper and lower dampers 42 and 43 for supporting the respective outer peripheral upper and lower surfaces of the vibration plate 41, and a pair of upper and lower housings 44 and 45 that is of an angle section type ring so as to fix the upper and lower dampers 42 and 43 together with the vibration plate 41 by surrounding the same. The end of the upper housing 44 may be bent toward the lower housing 45 and the end of the lower housing 45 may be bent toward the upper housing 44.

The vibration plate 41 has a body performing a main function vibration and an edge provided outside the body, and is made of ferromagnetic body, such as iron, nickel, silicon, or the like, like the upper and lower housings 44 and 45.

Since the outer periphery of the vibration plate 41 is supported by the upper and lower dampers 42 and 43 that is made of the soft material enabling the control of the elasticity modulus, the flexibility is increased over the entire outer peripheral support portion of the vibration plate 41, and thus the amplitude displacement is increased up and down, whereby the bass expansion and the acoustic conversion efficiency can be increased.

The upper and lower dampers 42 and 43 are preferably made of a nonmagnetic material that enables the control of the elasticity modulus so as to effectively perform damping on the vibration plate 41, such as, for example, a polymer, silicon, and synthetic resin.

The upper and lower housings 44 and 45 are made of a magnetic material so as to increase the bias magnetic force while minimizing magnetoresistance and leakage magnetic flux between the first and second permanent magnets 22 and 32, and to control the pressure of the dampers 42 and appropriately. Accordingly, by providing the braking force and the restoring force of the adequate compliance to the vibration plate 41, when the vibration plate is vibrated in the bass region, since the vibration plate is excluded from reverse phase and is driven to be same phase in the entire area, the phase difference distortion can be reduced and the acoustic conversion efficiency can be improved.

The vibration plate 41 and the upper and lower dampers 42 and 43 are integrated in one piece through the upper and lower housings 44 and 45 so as to provide the vibration module 40, whereby it is possible to automatize the assembling operation using a separate preparation process and minimizing the manual operation which can influence manufacturing cost.

The vibration plate 41 may be embossing processed only on the whole or a part of the body so as to suppress the plate-resonance of the vibration plate itself. Thus, the plate-resonance of the vibration plate itself may be suppressed by the embossing formed on the body of the vibration plate 41, which resulting that the distortion ratio can be reduced and the clear sound can be reproduced.

A soft cushion pad 55 may be provided on the top surfaces of the first permanent magnet 22 and the first coil 21 of the first magnetic circuit 20. The cushion pad 55 is not particularly limited as long as the through hole 55a having the same size as the inner diameter of the first coil 21 is perforated. The cushion pad 55 prevents the first coil 21 from being damaged when the top surface of the first magnetic circuit 20 is covered with the housing 10. The cushion pad 55 is also in close contact with the inner surface of the housing 10 to prevent leakage of sound to the outside, thereby preventing leakage of the bass.

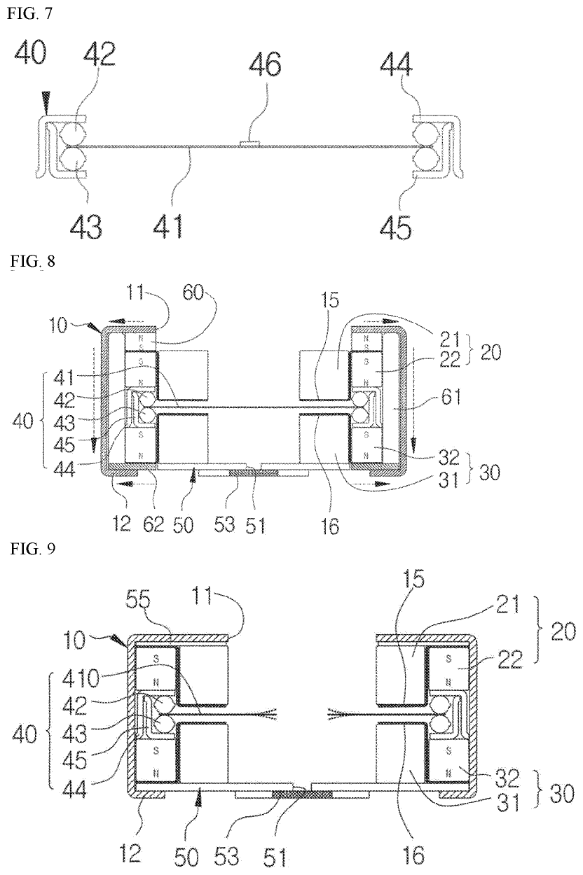

FIG. 7 is a cross-sectional view showing another embodiment of a vibration plate of a vibration module in an electromagnetic speaker according to the present invention. Here, the vibration plate 41 has the same structure as that of the vibration module of one embodiment except that an additional mass body 46 is provided at the center of the vibration plate 41.

According to the vibration plate of another embodiment as described above, since the additional mass body 46 is provided at the center of the vibration plate 41, the bass reproduction limit frequency of the electromagnetic speaker is lower due to the additional mass of the additional mass body 46, whereby it is possible to expand the bass reproduction limit frequency to a lower bass band. The kind of the additional mass body 46 is not particularly limited.

FIG. 8 is a cross-sectional view illustrating a high-quality electromagnetic speaker having improved accuracy of an air gap according to another embodiment of the present invention. Here, the electromagnetic speaker of this embodiment is the same as the electromagnetic speaker of one embodiment, except that the shield magnet 60 is provided so that the polarity of the upper surface of the first permanent magnet 22 is the same to that of the lower surface of the second permanent magnet 32; a ring-shaped shield guide 61 is provided to surround the outer peripheral surfaces of the shield magnet 60, as well as the vibration module 40 and the first and second permanent magnets 22 and 32; and a shield plate 62 is closely attached to the bottom surfaces of the second permanent magnet 32 and the shield guide 61 to provide a magnetic shielding speaker.

Herein, it is preferable that a thickness t of the shield guide 61 is equal to or larger than the thickness of the shield magnet 60 for reliable shielding treatment. In addition, the shield guide 61 is made of a non-magnetic material, the housing 10 is made of a magnetic material so as to function as a shield case, and the shield plate 62 is also made of a magnetic material.

According to the electromagnetic speaker of another embodiment configured as described above, since the first and second permanent magnets 22 and 32 are arranged to be in the same polarities by the shield magnet 60, the magnetic fields form closed loops through the housing 10 and the shield plate 62, which are a shield case, as shown in dotted line of FIG. 8, thereby attenuating the external leakage magnetic field and thus minimizing the external leakage of the magnetic field. That is, since the shield plate 62 contacts the N pole of the second permanent magnet and the housing 10 contacts the N pole of the shield magnet 60, it is possible to reduce the external leakage of the magnetic field by having the same pole.

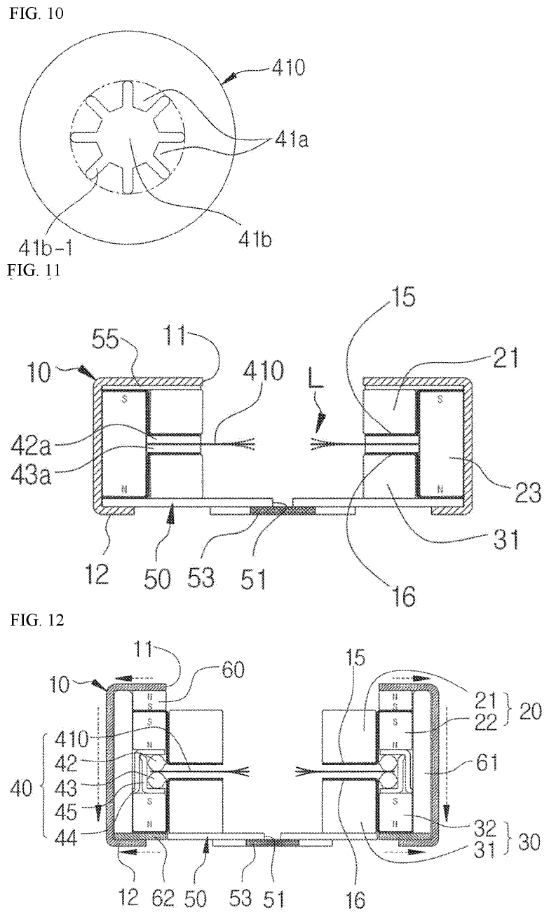

FIG. 9 is a cross-sectional view illustrating a high-quality electromagnetic speaker having improved accuracy of an air gap according to another embodiment of the present invention, and FIG. 10 is a plan view showing a vibration plate applied to the vibration module of FIG. 9. Here, the electromagnetic speaker of this embodiment is the same as the electromagnetic speaker of one embodiment, except that the electromagnetic speaker is provided as an open-type treble vibration plate 410 in which a plurality of extension holes 41b -1 cut radially in a center hole 41b that is the center of the vibration plate, and a plurality of vibrating blades 41a disposed between the plurality of extension holes 41b -1 are formed in the vibration plate of the vibration module 40.

According to the electromagnetic speaker of another embodiment configured as described above, in the state where the outer peripheral edge, which is the edge of the vibration plate 410, is supported by the upper and lower dampers 42 and 43 of the vibration module 40, the vibrating blades 41a vibrate while performing the circular motion upward and downward as shown in an imaginary line L of FIG. 9 on the basis of the same circumference of the first and second vibrating blades 41a and 41a.

Accordingly, the center hole 41b and the plurality of extension holes 41b -1 formed between the vibrating blades 41a of the treble vibration plate 410 enable that the bass region generated by the vibrating blades 41a cancels itself in reverse phase, and only the treble sound generated by the circular motion of the vibrating blades 41a is emitted, thereby obtaining the treble speaker of the electromagnetic type.

FIG. 11 is a cross-sectional view illustrating a high-quality electromagnetic speaker having improved accuracy of an air gap according to another embodiment of the present invention. Here, the high-quality electromagnetic speaker is provided as a slim-type treble speaker in which the first and second fixing members 15 and 16 are provided symmetrically on both ends of one permanent magnet 23 to cause the first and second coils 21 and 22 to be safely positioned, and a treble vibration plate 410 is provided by first and second soft magnetic dampers 42a and 43a interposed between the first and second fixing members 15 and 16. The first and second magnetic dampers 42a and 43a may be formed of a flexible magnetic material in which a ferromagnetic powder or particle (iron, nickel, silicon metal, cobalt, etc.) is mixed with soft materials such as polymer or silicon.

According to the electromagnetic speaker of another embodiment configured as described above, since the first and second soft magnetic dampers 42a and 43a support the edge portions of the treble vibration plate 410, it is possible to absorb plate resonance, as well as unnecessary split vibration and parasitic vibration generated in the treble vibration plate 410, whereby it is advantageous in distortion reduction and clear sound reproduction, and the magnetic conversion efficiency improves due to reduction in magnetoresistance between the first and second coils 21 and 22 and the treble vibration plate 410.

Unlike the electromagnetic speaker of one embodiment adopting a pair of the first and second permanent magnets and the vibration module, the electromagnetic speaker according to this embodiment is provided such that one permanent magnet 23 is provided and the treble vibration plate 410 is supported only by the first and second magnetic damper 42a and 43a , the height of the speaker itself can be further lowered, and the slimness can be achieved while reducing the manufacturing cost thereof.

FIG. 12 is a cross-sectional view illustrating a high-quality electromagnetic speaker having improved accuracy of an air gap according to another embodiment of the present invention. Here, a high-quality electromagnetic speaker according to this embodiment is the same to the electromagnetic speaker according the one embodiment, except the treble vibration plate 410 is applied to the vibration plate of the vibration module 40 of the magnetic shielding type full-band electromagnetic speaker that is shown in FIG. 8.

According to the electromagnetic speaker of another embodiment configured as described above, the magnetic shielding type electromagnetic speaker is provided so that the first and second permanent magnets 22 and 32 are arranged to be in the same polarity by the shield magnet 60, and the magnetic fields form closed loops through the housing 10 and the shield plate 62, which are a shield case, thereby attenuating an external leakage magnetic field. By applying the treble vibration plate 410 as shown in FIG. 10, the bass region generated by the vibrating blades 41a cancels itself in reverse phase using the plurality of extension holes 41b -1 formed in the vibrating blades 41a , so that only the treble sound generated by the circular motion of the vibrating blades 41a is emitted, thereby obtaining the magnetic shielding type treble electromagnetic speaker.

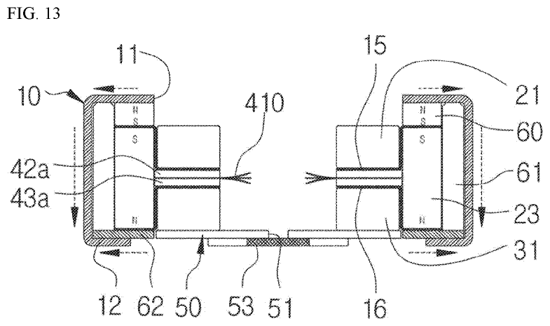

FIG. 13 is a cross-sectional view illustrating a high-quality electromagnetic speaker having improved accuracy of an air gap according to another embodiment of the present invention. Here, the high-quality electromagnetic speaker according to this embodiment is provided as a slim type treble speaker as shown in FIG. 11 in which a treble vibration plate 410 is disposed together with first and second coils 21 and 22 inward of one permanent magnet 23. Also, the high-quality electromagnetic speaker according to this embodiment is a slim magnetic shielding type treble speaker in which the shield magnet 60 is provided so that the polarity of the upper surface of the permanent magnet 23 is the same to that of the lower surface pole of the permanent magnet 23, and a ring type shield guide 61 for covering the outer peripheral surface of the permanent magnet 23 and the shield magnet 60 and a shield plate 62 provided on the lower surfaces of the permanent magnet 23 and the shield guide 61 to be in close contact therewith are provided.

According to the electromagnetic speaker of another embodiment configured as described above, since the first and second soft magnetic dampers 42a and 43a and the treble vibration plate 410 are employed, it is possible to absorb plate resonance, as well as unnecessary split vibration and parasitic vibration generated in the treble vibration plate 410, whereby it is advantageous in distortion reduction and clear sound reproduction, and the magnetic conversion efficiency is improved due to reduction in magnetoresistance between the first and second coils 21 and 22 and the treble vibration plate 410.

According to the magnetic shielding speaker of this embodiment, the permanent magnets 23 and the shield magnets 60 are arranged to be in the same polarity so that their magnetic fields form closed loops through the housing 10 and the shield plate 62, which are a shield case, as indicated by dotted lines, thereby attenuating the external leakage of magnetic field, and minimizing the external leakage of the magnetic field.

While the present invention has been particularly shown and described with reference to exemplary embodiments thereof, it is to be understood that the invention is not limited to the disclosed exemplary embodiments, and all of the design change elements will be included in the present invention as long as the driving principle and the arrangement of the parts are consistent with the equivalent concept of the present invention.

1. A high-quality electromagnetic speaker having improved accuracy of an air gap, the speaker comprising:
a vibrating module including a vibrating plate;
a first magnetic circuit disposed in an upper part of the vibration module; and
a second magnetic circuit disposed in a lower part of the vibration module,
wherein the first magnetic circuit includes a first permanent magnet disposed in the upper part of the vibration module, a first coil disposed inward of the first permanent magnet, and a first fixing member formed to protrude toward the second magnetic circuit to fix the first coil; and
the second magnetic circuit includes a second permanent magnet disposed in the lower part of the vibration module, a second coil disposed inward of the second permanent magnet, and a second fixing member formed to protrude toward the first magnetic circuit to fix the second coil.

2. The speaker of claim 1, wherein the first coil is disposed to be flattened with a top surface of the first permanent magnet and protrudes from a bottom surface of the first permanent magnet,
the second coil is disposed to be flattened with a bottom surface of the second permanent magnet and protrudes from a top surface of the second permanent magnet, and the first coil and the second coil are disposed so that air gaps are formed mutually symmetrically at an equal distance with respect to the vibration plate.

3. The speaker of claim 1, wherein the vibration module includes ring-shaped upper and lower dampers for supporting the top and bottom surfaces of the vibration plate, and upper and lower housings for fixing the upper and lower dampers together with the vibration plate, and the upper and lower housings have an angle type cross section.

4. The speaker of claim 3, wherein the vibration plate has a mass body disposed at the center thereof.

5. The speaker of claim 3, wherein the vibration plate includes a plurality of extension holes extending radially in a center hole and a plurality of vibration blades disposed between the plurality of extension holes.

6. The speaker of claim 1, further comprising:
a cushion pad disposed between the first magnetic circuit and an inner surface of the housing to prevent acoustic leakage and prevent damage to the coil.

7. The speaker of claim 1, further comprising:
a shield magnet disposed so that a polarity of an upper surface of the first permanent magnet is the same to that of a lower surface of the second permanent magnet;
a shield guide surrounding outer surfaces of the vibration module, the first and second permanent magnets, and the shield magnet; and
a shield plate disposed on bottom surfaces of the second permanent magnet and the shield guide,
wherein the shield guide is a non-magnetic body, and the shield plate is a magnetic body.

8. A high-quality electromagnetic speaker having improved accuracy of an air gap, the speaker comprising:
a vibrating plate;
a first coil disposed on an upper part of the vibration plate;
a second coil disposed on a lower part of the vibration plate; and
permanent magnets disposed outward of the first coil and the second coil,
wherein a first fixing member and a second fixing member are provided symmetrically on both ends of the permanent magnets to cause the first coil and the second coil to be safely positioned, and
a treble vibration plate is provided through a first soft magnetic damper and a second soft magnetic damper disposed between the first fixing member and the second fixing member.

9. The speaker of claim 8, wherein the first and second magnetic dampers includes a polymer resin and particles dispersed in the polymer resin, and the particles include ferromagnetic powder or particles.
